(19) United States
(12) Patent Application Publication
(10) Pub. No.: US 2011/0069984 A1
(43) Pub. Date: Mar. 24, 2011

(54) FIXING DEVICE, IMAGE FORMING APPARATUS AND METHOD FOR FIXING IMAGE

(75) Inventor: Takaho WATANABE, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/860,476

(22) Filed: Aug. 20, 2010

Related U.S. Application Data
(60) Provisional application No. 61/244,727, filed on Sep. 22, 2009.

(30) Foreign Application Priority Data
Jun. 15, 2010 (JP) P2010-135829
Jul. 5, 2010 (JP) P2010-152813

(51) Int. Cl. G03G 15/20

(52) U.S. Cl. 399/67; 399/329

(57) ABSTRACT

According to one embodiment, a fixing device includes a fixing roller having an elastic layer, a fixing belt wound around the fixing roller, a satellite roller to set up the fixing belt between the fixing roller and the satellite roller, a pressing roller to nip hold the fixing belt between the fixing roller and the pressing roller, a separator to separate a sheet at a position separate from the fixing belt, a pressure changing mechanism to change a nip pressure between the fixing roller and the pressing roller, and a driving device to rotate the fixing belt in a first direction when the nip pressure is a first nip pressure and to rotate the fixing belt in a second direction which is reverse to the first direction when the nip pressure is a second nip pressure which is lower than the first nip pressure.

### CROSS REFERENCE TO RELATED APPLICATIONS

This application is based upon and claims the benefit of priority from the prior U.S. Patent Application No. 61/244,727, filed on Sep. 22, 2009, the entire contents of which are incorporated herein by reference.

This application is also based upon and claims the benefit of priority from Japanese Patent Application No. 2010-135829, filed on Jun. 15, 2010; and Japanese Patent Application No. 2010-152813, filed on Jul. 5, 2010, the entire contents of which are incorporated herein by reference.

### FIELD

Exemplary embodiments described herein relate to a fixing device loaded in an image forming apparatus to fix a toner image on a sheet.

### BACKGROUND

An image forming apparatus such as a copy machine of an electro photographic system and a printer selectively exposes on a drum shaped photoconductor, for example, whose surface is charged uniformly, to form a latent image, and develops the latent image by toner. And the image forming apparatus transfers a toner image which is developed on the photoconductor onto a sheet, and fixes the image on the sheet by passing the sheet through a fixing nip formed by a fixing belt, a fixing roller and a pressing roller composing a fixing device. That is, the image forming apparatus fixes the image on the sheet by rotating the fixing roller and the pressing roller under a high nip pressure via the fixing belt which is heated up to a fixing temperature and by applying heat and pressure.

In the fixing device, in the state except fixing, the fixing roller and the pressing roller are rotated via the fixing belt in the state that the nip pressure is low so as to expand the life of the fixing belt, the fixing roller and the pressing roller. In such the fixing device, in case that the fixing roller and the pressing roller are rotated while keeping the nip pressure low, a flexure of the fixing belt may happen, and the flexure of the fixing belt may happen to make contact with a separator member positioning at the downstream side than the nip in the conveying direction of the sheet.

### BRIEF DESCRIPTION OF THE DRAWINGS

FIG. 1 is a schematic construction view showing an image forming apparatus loaded with a fixing device in a first embodiment;

FIG. 2 is a front view of the fixing device in the first embodiment;

FIG. 3 is a schematic construction view of the fixing device in the first embodiment seen from above;

FIG. 4 is a view showing a gear sequence in the first embodiment;

FIG. 5 is a perspective view of the gear sequence in the first embodiment;

FIGS. 6A and 6B are views, each showing a fixing roller and a pressing roller in the first embodiment;

FIG. 7 is a block diagram showing a controller of the fixing device in the first embodiment;

FIG. 8 is a flow chart showing an operation of the image forming apparatus in the first embodiment;

FIG. 9 is a view showing a gear sequence in a second embodiment;

FIG. 10 is a flow chart showing an operation of an image forming apparatus in the second embodiment; and

FIGS. 11A and 11B are views, each showing a fixing roller and a pressing roller in a modification.

### DETAILED DESCRIPTION

In general, according to one embodiment, there is provided a fixing device including: a fixing device includes a fixing roller having an elastic layer, a fixing belt wound around the fixing roller, a satellite roller to set up the fixing belt between the fixing roller and the satellite roller, a pressing roller to nip hold the fixing belt between the fixing roller and the pressing roller, a separator to separate a sheet at a position separate from the fixing belt, a pressure changing mechanism to change a nip pressure between the fixing roller and the pressing roller, and a driving device to rotate the fixing belt in a first direction when the nip pressure is a first nip pressure and to rotate the fixing belt in a second direction which is reverse to the first direction when the nip pressure is a second nip pressure which is lower than the first nip pressure.

Hereinafter, best embodiments of a fixing device, an image forming apparatus and a method for controlling an image fixing device will be described in detail with reference to the accompanying drawings.

### First Embodiment

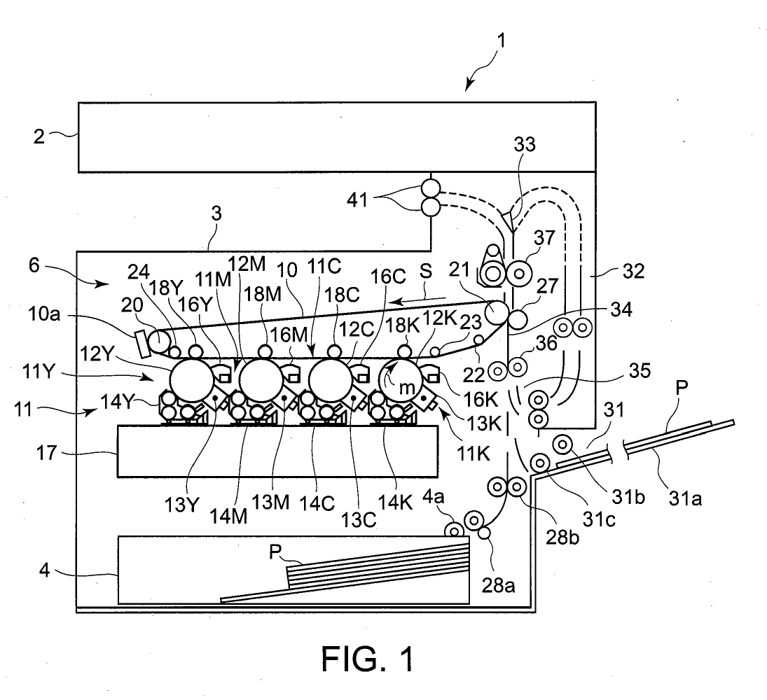

FIG. 1 is a schematic construction view showing an internal construction example of an image forming apparatus 1 loaded with a fixing device 37 of a first embodiment.

The image forming apparatus 1 includes a scanner 2, a sheet ejector 3 and an image forming portion 6. The scanner 2 reads out an image on a document as a color image data (an image data with many values) or a monochrome image data (an image data with two values) by scanning the document face optically. The sheet ejector 3 houses a sheet P which was image formed and ejected from the chassis of the apparatus.

The image forming portion 6 forms an image on the sheet P based on the color image data or the monochrome image data. The image forming portion 6 has an image forming unit 11 including four image forming stations 11Y, 11M, 11C and 11K of yellow (Y), magenta (M), cyan (C) and black (K) arranged in parallel with along a lower side of an intermediate transfer belt 10.

As each of the image forming stations 11Y, 11M, 11C and 11K has the same construction, accordingly, the construction and function will be described with respect to the image forming station 11K for black use, and with respect to the other image forming stations, the detailed description will be omitted by giving corresponding references.

The image forming station 11K includes a photoconductor drum 12K. Around the photoconductor drum 12K, a charger 13K, a developing device 14K and a photoconductor cleaning device 16K are arranged along a rotation direction shown by an arrow m. Exposing light is irradiated by a laser exposing device 17 on a drum surface of the photoconductor drum 12K at a position between the charger 13K and the developing device 14K. When the exposing light is irradiated, an electrostatic latent image is formed on the rotating photoconductor drum 12K.

The developing device 14K has a two-component black (K) developer composed of toner and carrier, for example. The developing device 14K feeds black toner to the electrostatic latent image on the photoconductor drum 12K.

The intermediate transfer belt 10 is set up by a backup roller 21, a driven roller 20 and a first to a third tension roller 22 to 24. The intermediate transfer belt 10 faces to and contacts with the photoconductor drums 12Y, 12M, 12C and 12K. At the positions of the intermediate transfer belt 10 facing the photoconductor drums, 12Y, 12M, 12C and 12K, primary transfer rollers 18Y, 18M, 18C and 18K are provided so as to primarily transfer the images formed on the photoconductor drums 12Y, 12M, 12C and 12K which are the toner images to the intermediate transfer belt 10, respectively. Each of the toner images of each color formed on each of the photoconductors is sequentially transferred on the intermediate transfer belt 10 by each of the primary transfer rollers to become a color image.

At a secondary transfer portion of the intermediate transfer belt 10, a secondary transfer roller 27 is arranged. At the secondary transfer portion, a secondary transfer bias is applied to the backup roller 21. Below the laser exposing device 17, a sheet cassette 4 is provided to feed the sheet P to the secondary transfer roller 27. At the right side of the image forming apparatus 1, a manual sheet feeder 31 to feed the sheet P manually is provided.

At the positions between the sheet cassette 4 and the secondary transfer roller 27, a pickup roller 4a, a separation roller 28a, a conveying roller 28b and an aligning roller 36 are provided so as to convey the sheet P from the sheet cassette 4. At the positions between a manual sheet feed tray 31a of the manual sheet feeder 31 and the aligning roller 36, a manual sheet pickup roller 31b and a manual sheet separation roller 31c are provided so as to convey the sheet P on the manual sheet feed tray 31a.

While the sheet P is sandwiched and conveyed between the intermediate transfer belt 10 and the secondary transfer roller 27, the toner image on the intermediate transfer belt 10 is secondarily transferred on the sheet P. After the secondary transfer is finished, the intermediate transfer belt 10 is cleaned by a belt cleaner 10a. Along the running direction of the sheet p, a fixing device 37 is provided at the downstream of the secondary transfer roller 27. The sheet p fed from the sheet cassette 4 or the manual sheet feeder 31 is conveyed along a conveying path 34 to the fixing device 37 through the aligning roller 36 and the secondary transfer roller 27.

At the downstream of the fixing device 37, a gate 33 is provided, which sorts the sheet P in a direction for an ejection roller 41 or in a direction for a re-conveying unit 32. The sheet P guided to the ejection roller is ejected to the sheet ejector 3. The sheet guided to the re-conveying unit 32 is guided again in a direction for the secondary transfer roller 27.

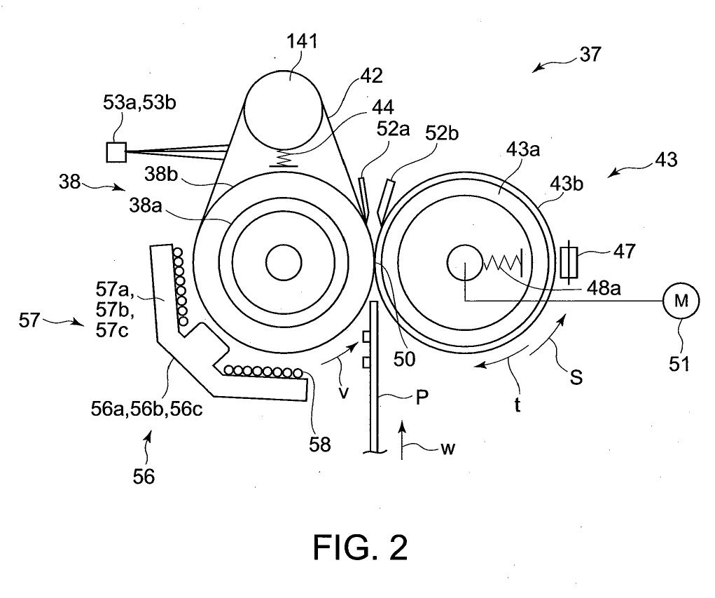

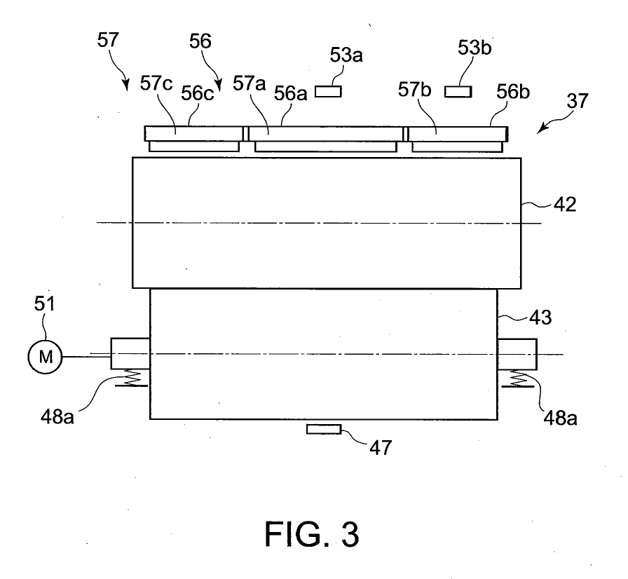

FIG. 2 is a schematic construction view of the fixing device 37 seen from the front, and FIG. 3 is a schematic construction view of the fixing device 37 seen from above. The fixing device 37 has an endless fixing belt 42 wound around a fixing roller 38 and a satellite roller 141 and a pressing roller 43. The fixing roller 38 is formed by coating a foamed rubber (sponge) layer 38b with a thickness of 8.5 mm as an elastic layer around a cored bar 38 with a thickness of 2 mm, for example. The outer diameter of the fixing roller 38 is 48.5 mm, for example. The outer diameter of the satellite roller 141 is 17 mm, for example. The satellite roller 141 is formed by coating on the surface of an aluminum metallic pipe, for example. Material for the metallic pipe may be iron, copper and stainless, and so on. In addition, in place of the metallic pipe, a heat pipe with further higher heat conductivity may be used. The satellite roller 141 is harder and is less deformable compared with the elastic layer of the fixing roller 38. A spring 44 biases the satellite roller 141 in a back away direction from the fixing roller 38.

The fixing belt 42 comprises by sequentially laminating a solid rubber layer with a thickness of 200 μm of silicone rubber and a release agent layer with a thickness of 30 μm of a PTFE (Polytetrafluoroethylene) tube on a nickel metallic conductive layer with a thickness of 40 μm, for example, which is a metallic layer. The fixing belt 42 has an outer diameter of 60 mm, when formed in a cylindrical shape. The fixing belt 42 is set up around the fixing roller 38 and the satellite roller 141 by the spring 44.

The fixing device 37 includes a belt heating portion which will be separately described at the outer circumference of the fixing belt 42, and the fixing belt 42 is heated to a fixing temperature by the belt heating portion.

A first temperature sensor 53a to detect a temperature of a center portion of the fixing belt 42 which is heated as described above and a second temperature sensor 53b to detect a side portion of the fixing belt 42 are arranged around the fixing belt 42. As the first temperature sensor 53a and the second temperature sensor 53b, a thermopile sensor to detect infra-red ray without contacting is used, for example. Using the first temperature sensor 53a and the second temperature sensor 53b, the temperature distribution of the fixing belt 42 in the width direction is controlled. The number of the temperature sensors to detect the temperatures of the fixing belt 42 is not limited to two. By providing the three temperature sensors, and by measuring the temperatures at the center portion and both the side portions of the fixing belt 42, the temperature distribution in the width direction may be controlled.

The pressing roller 43 has a rubber layer 43b around a cored bar 43a, for example. The outer diameter of the pressing roller 43 is 50 mm, for example. As the rubber layer, silicone rubber or fluorine-containing rubber is used. The pressing roller 43 has a roller temperature sensor 47 at the circumference. The pressing roller 43 pressing contacts to the fixing roller 38 and the fixing belt 42. By pressure contacting the pressing roller 43, a nip portion 50 is formed between the fixing belt 42 and the pressing roller 43. To plan further speeding up FCOT (First Copy Output Time) is possible by providing a heating device such as an electromagnetic induction heater or a halogen lamp. A pressure of the pressing roller 43 against the fixing roller 38 which is a nip pressure can be adjusted.

The pressing roller 43 rotates in a direction of an arrow t by a drive motor 51 which is a driving portion. Hereinafter, a rotation in the direction of the arrow t is determined as a forward rotation, and a rotation in a direction of an arrow s which is a direction reverse to the direction of the arrow t is determined as a reverse direction. The fixing roller 38, the satellite roller 141 and the fixing belt 42 rotate in a direction of an arrow v while driven by the pressing roller 43. The driving speed of the drive motor 51 can be adjusted.

The fixing device 37 fixes the toner image on the sheet P passing through the nip portion 50 between the fixing belt 42 and the pressing roller 43 from the upstream side to the downstream side in a direction of an arrow w. With respect to the sheet P adhered to the fixing belt 42 and the pressing roller 43 by the toner melted by heat and the nip pressure, a separator 52a to separate the sheet P from the fixing belt 42 and a separator 52b to separate the sheet P from the pressing roller 43 are provided at the downstream side of the nip portion 50. A width between the fixing belt 42 and the separator 52a is about 0.3 mm to 0.5 mm.

The fixing device 37 has a coil 56 and a magnetic body 57 which are a belt heating portion. A first coil 56a makes a center portion including a center in the width direction of the fixing belt 42 generate heat. A second coil 56b and a third coil 56c make both side portions not including the center in the width direction of the fixing belt 42 generate heat. The second coil 56b and the third coil 56c are connected in series, and are driven under the same control. The first coil 56a, the second coil 56b and the third coil 56c are driven by being changed selectively. In any coils, an output can be adjusted at 200 W to 1500 W, for example.

Each of the coils 56a to 56c includes a conducting wire 58 wound around each of magnetic cores 57a to 57c. As the conducting wire 58, a litz wire is used which is formed by binding up sixteen cupper wire rods each with a diameter of 0.5 mm coated with heat-resisting polyamide-imide. When high-frequency current is flown through the conducting wire 58, each of the coils 56a to 56c generates magnetic flux. By the magnetic flux, Joule heat generates by the resistance value of the metallic conductive layer of the fixing belt 42, and the fixing belt 42 generates heat instantaneously. The high-frequency current to be flown through each of the coils 56a to 56c is in a range of frequency of 20 to 100 kHz, for example.

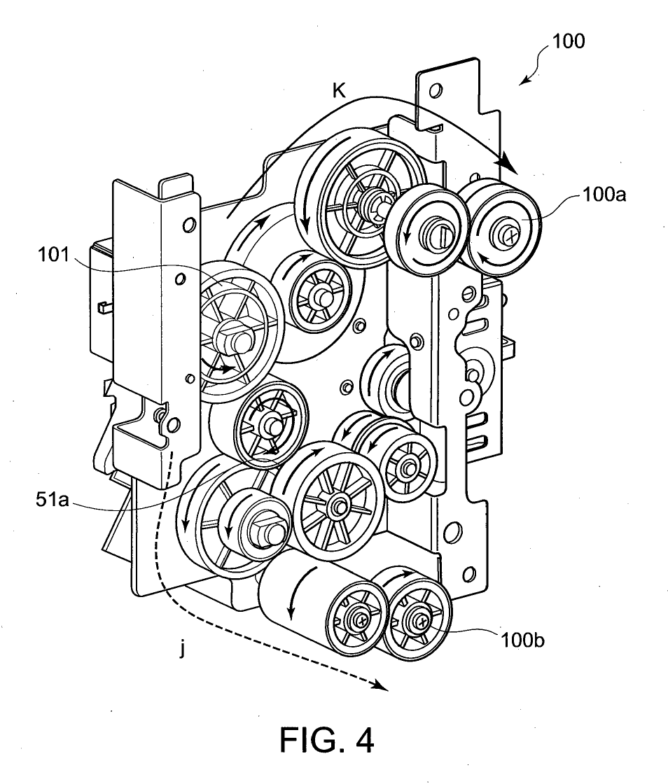

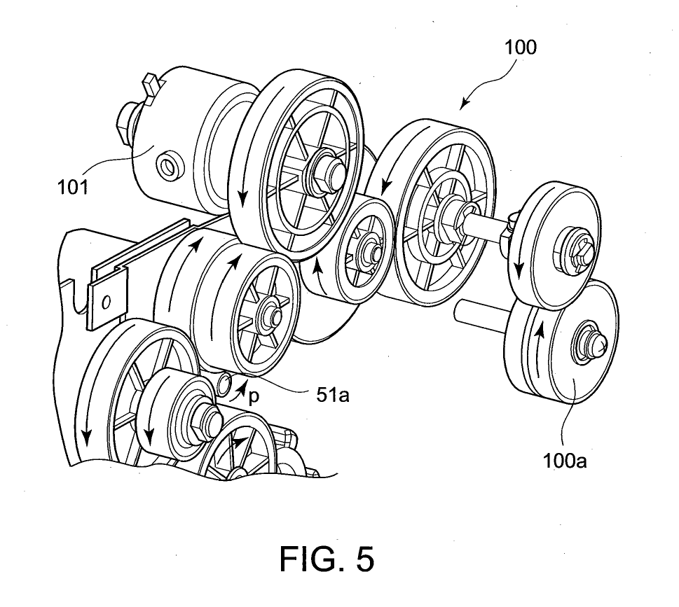

FIG. 4 is a view showing a gear sequence 100 to control a rotation direction of the pressing roller 43 and the nip pressure, and FIG. 5 is a view showing a perspective view of the gear sequence 100. The gear sequence 100 is provided at a side face of the fixing device 37.

The gear sequence 100 as a driving device has a plurality of gears, a motor shaft 51a and an electromagnetic clutch gear 101. The drive motor 51 whose rotation direction is controlled by a CPU 72 described later drives the motor shaft 51a. The motor shaft 51a rotates in a direction p shown in FIG. 5 and a reverse direction of the direction p. The motor shaft 51a rotates forwardly in the direction p. The motor shaft 51a rotates reversely in the reverse direction of the direction p. The motor shaft 51a rotates adjacent gears.

A gear 100a rotates a cam 81 and a shutter 83. A gear 100b rotates the pressing roller 43.

The electromagnetic clutch gear 101 is a clutch to switch over whether to transmit or to cut the rotation of the motor shaft 51a to the cam 81. The electromagnetic clutch gear 101 is a two-stage gear composed of an upper stage and a lower stage, and the operation changes by whether or not to flow the current. The lower stage gear connects so as to rotate gears in a direction of an arrow j, and the upper stage gear connects so as to follow with the rotation of gears in a direction of an arrow k. When current is flown, the upper stage along with the lower stage of the two-stage gear rotate, and rotate gears in the direction of the arrow k, which are ranging to the gear 100a. When the current is cut off, the gear of the lower stage runs idle and the gear of the upper stage rotates.

At the time of the forward rotation, the motor shaft 51a rotates forwardly the electromagnetic clutch gear 101 and the gears in the direction of the arrow j. When the gear 100b rotates forwardly, the pressing roller 43 rotates forwardly in the direction of the arrow t in FIG. 2. With respect to the fixing belt 42 which is rotated by the forwardly rotating pressing roller 43, a face facing the separator 52a goes slack.

At the time of reverse rotation, the motor shaft 51a rotates reversely the electromagnetic clutch gear 101 and the gears in the direction of the arrow j. When the gear 100b rotates reversely, the pressing roller 43 rotates reversely. With respect to the fixing belt 42 which is rotated reversely by the rotating pressing roller 43, a face facing the separator 52a goes tight.

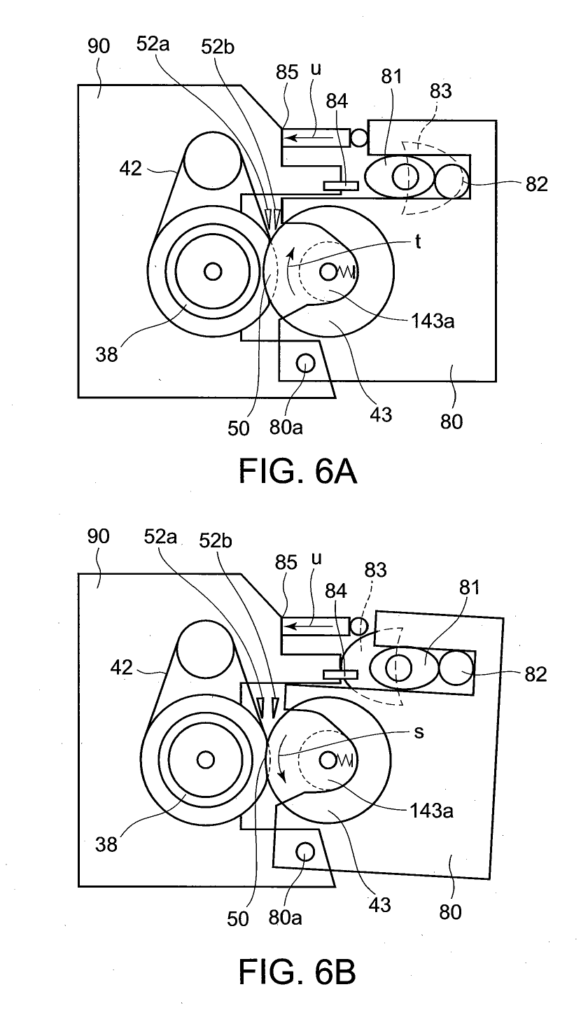

A concrete example of a mechanism to adjust a pressing power of the pressing roller 43 against the fixing roller 38 will be described. FIG. 6A is a view showing a state where the nip pressure is high, and FIG. 6B is a view showing a state where the nip pressure is low.

The fixing device 37 includes, as a pressure changing mechanism, a pressing roller frame 80, the cam 81, a bearing 82, the shutter 83, a sensor 84, a pressure spring 85, a fixing roller frame 90, for example.

The fixing roller frame 90 supports rotatably the fixing roller 38. The fixing roller frame 90 supports a supporting point 80a. The fixing roller frame 90 supports the sensor 84. The pressing roller frame 80 rotates regarding the supporting point 80a as the center against the fixing roller frame 90. A pressing roller shaft 143a is supported by the pressing roller frame 80. When the pressing roller frame 80 rotates regarding the supporting point 80a as the center, the pressing roller 43 along with the pressing roller shaft 143a rotate against the fixing roller frame 90.

The cam 81 is of an ellipse shape, and supported by the shaft eccentrically and is rotatable. As the cam 81 is eccentric, there are a cam face distant from the rotation center and a cam face near the rotation center. When the cam face near the rotation center of the cam 81 contacts with the bearing 82, the nip pressure is high. When the cam 81 rotates so that the cam face distant from the rotation center of the cam 81 makes contact with the bearing 82, the pressing roller frame 80 rotates in a direction to separate from the fixing roller 38, and the nip pressure lowers. If the nip pressure lowers, as the foamed rubber layer 38b which is crushed by the high nip pressure is restored, the fixing belt 42 approaches the separator 52a.

The bearing 82 constantly contacts with the cam face of the cam 81 to operate as a follower, and moves by the rotation of the cam 81.

The shutter 83 is fan-like as shown in FIG. 6, and is coaxial with the cam 81. A tip portion of the cam 83 projects in a direction of the cam face near the rotation center of the cam 81. The tip portion of the cam 83 may project in a direction of the cam face distant from the rotation center of the cam 81.

The sensor 84 has a detecting concave portion, for example, so that the shutter 83 overpasses the sensor 84, and a light emitting element faces a light receiving element across the detecting concave portion. When the shutter 83 does not shield the detecting concave portion of the sensor 84 as shown in FIG. 6A, the nip pressure is high. When the shutter 83 shields the detecting concave portion of the sensor 84 as shown in FIG. 6B, the nip pressure is low. The CPU 72 discriminates from an output of the sensor 84 whether or not the shutter 83 shields the detecting concave portion of the sensor 84. The pressing spring 85 biases the pressing roller frame 80 toward the fixing roller frame 90 (in a direction of an arrow u).

In the case of moving from a state where the nip pressure is high to a state where the nip pressure is low, current is flown in the electromagnetic clutch gear 101. The lower stage along with the upper stage of the electromagnetic clutch gear 101 rotate. When the gear 100 rotates by 180°, the cam 81 fixed coaxially rotates by 180°. When the shutter 83 comes to the detecting concave portion of the sensor 84 and shields the sensor 84, to flow the current in the electromagnetic clutch gear 101 is stopped, and the came 81 stops in the state that the cam face distant from the rotation center of the cam 81 makes contact with the bearing 82. Along with the rotation of the cam 81, the pressing roller frame 80 rotates regarding the supporting point 80a as the center in a direction to separate from the fixing roller 38, and becomes the state where the nip pressure is low.

On the other hand, in the case of moving from a state where the nip pressure is low to a state where the nip pressure is high, current is flown in the electromagnetic clutch gear 101 in the same manner as moving to the state where the nip pressure is low. When the gear 100 rotates by 180°, the cam 81 fixed coaxially rotates by 180°. When the shutter 83 separates from the detecting concave portion of the sensor 84 and no one shields the detecting concave portion, to flow the current in the electromagnetic clutch gear 101 is stopped, and the came 81 stops in the state that the cam face near the rotation center of the cam 81 makes contact with the bearing 82. Along with the rotation of the cam 81, the pressing roller frame 80 rotates regarding the supporting point 80a as the center in a direction to approach the fixing roller 38, and becomes the state where the nip pressure is high.

In the first embodiment, the pressing roller 43 rotates reversely in the direction of the arrow s in the state where the nip pressure is low. By expanding a distance between the shafts of the fixing roller 38 and the pressing roller 43 compared with in the fixing mode, in the state where an area of the nip portion 50 formed by the fixing belt 42 and the pressing roller 43 decreases, the fixing belt 42 and the pressing roller 43 rotate in a direction reverse to the rotating direction in the fixing mode. To start transiting from the state where the nip pressure is high to the state where the nip pressure is low and to start rotating reversely the pressing roller 43 may be concurrent.

The distance between the shafts of the fixing roller 38 and the pressing roller 43 is determined as a distance to connect the rotation center of the fixing roller 38 and the rotation center of the pressing roller 43, for example. Assuming that the diameter of the fixing roller 38 is 30 mm φ, and the diameter of the pressing roller is 30 mm φ, the distance between the shafts becomes 29 mm in the state where the nip pressure is low, and becomes 27 to 28 mm in the state where the nip pressure is high, for example.

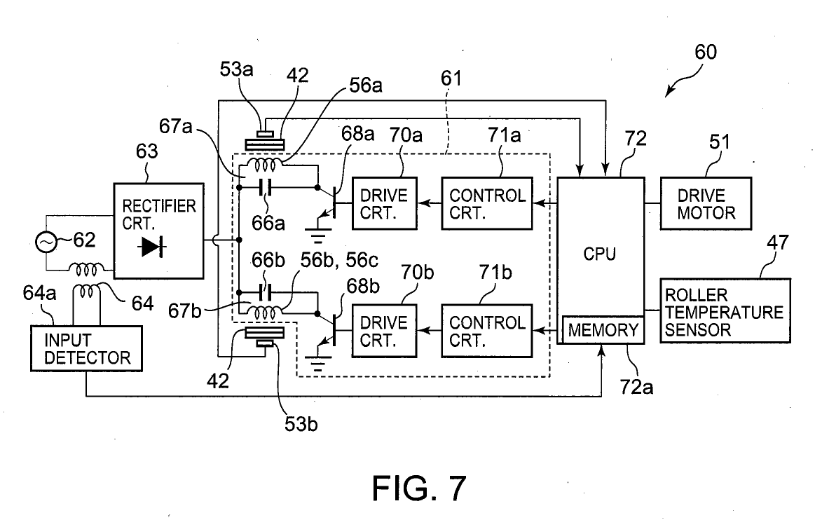

FIG. 7 shows a controller 60 of the fixing device 37. The controller 60 has an inverter circuit 61 to control power supplied to each of the coils 56a to 56c. The controller 60 has a rectifier circuit 63 to supply a DC current obtained by smoothing the current from a commercial AC source 62 to the inverter circuit 61. A transformer 64 is arranged at a former stage of the rectifier circuit 63, and an overall consumption power can be detected via an input detector 64a.

The controller 60 has the CPU 72 to control the inverter circuit 61 in accordance with the detection results of the first temperature sensor 53a and the second temperature sensor 53b. The CPU 72 controls the drive motor 51 in accordance with the detection results of the first temperature sensor 53a and the roller temperature sensor 47. The power detected by the input detector 64a is fed back to the CPU 72.

The CPU 72 realizes various functions by executing the program stored in a memory 72a as a controller, and executes various processing of the image forming apparatus 1 including the fixing device 37 and so on.

The memory 72a is a RAM (Random Access Memory), a ROM (Read Only Memory), a DRAM (Dynamic Random Access Memory), a SRAM (Static Random Access Memory), a VRAM (Video RAM) and so on, for example, and has a function to store the various information and programs utilized in the image forming apparatus 1. The memory 72a stores a table to set the temperature and speed of the fixing device 37.

In the inverter circuit 61, a first capacitor 66a for resonance use is connected in parallel with the first coil 56a to form a first resonance circuit 67a, and a second capacitor 66b for resonance use is connected in parallel with the second coil 56b and the third coil 56c to form a second resonance circuit 67b. In the inverter circuit 61, a first switching element 68a connects to the first resonance circuit 67a, and a second switching element 68b connects to the second resonance circuit 67b.

A first drive circuit 70a and a second drive circuit 70b respectively connect to control terminals of the first switching element 68a and the second switching element 68b. The first and second drive circuits 70a, 70b connect to the CPU 72 via first and second control circuits 71a, 71b, respectively. The first control circuit 71a and the second control circuit 71b are instructed by the CPU 72, and control ON times of the first and second switching elements 68a, 68b via the first drive circuit 70a and the second drive circuit 70b, respectively. By controlling the ON times of the first switching element 68a and second switching element 68b, the frequency is changed variably in a range of 20 to 100 kHz to change an output value.

A control process of the fixing device 37 will be described. After the power source is switched ON and the image forming apparatus 1 is started, the control process of the fixing device 37 is started. The control process of the fixing device 37 has a warming up mode, a ready mode, a fixing mode, a preheat mode, a sleep mode, a preheat return mode, and a sleep return mode.

In the warming up mode, after starting the image forming apparatus 1 by making the power source ON, the fixing device 37 becomes at fixing temperatures. An fixing temperature of the fixing belt 42 is 160° C., for example. An fixing temperature of the pressing roller 43 is 80° C., for example. The nip pressure in the warming up mode is high. In the warming up mode, the drive motor 51 rotates forwardly the pressing roller 43 at 270 mm/sec.

In the ready mode, the fixing belt 42 and the pressing roller 43 are held at the fixing temperatures. The nip pressure in the ready mode is lower than the nip pressure in the warming up mode. In the ready mode, the drive motor 51 rotates reversely the pressing roller 43 at 90 mm/sec.

In the fixing mode, the fixing belt 42 and the pressing roller 43 are held at the fixing temperatures. The nip pressure in the fixing mode is high in such an extent to fix sufficiently at the fixing temperatures. The nip pressure in the fixing mode is higher than the nip pressure in the ready mode. The nip pressure in the fixing mode may be made equal to the nip pressure in the warming up mode. In the fixing mode, the drive motor 51 rotates forwardly the pressing roller 43 at 270 mm/sec.

In the preheat mode, the fixing belt 42 is held at a preheat temperature. The preheat temperature of the fixing belt 42 is lower than the fixing temperature of the fixing belt 42. The preheat temperature is 80° C., for example. The image forming apparatus 1 changes to the preheat mode, when a certain time (three minutes, for example) elapses in the ready mode constantly. The nip pressure in the preheat mode is lower than the nip pressure in the warming up mode. In the preheat mode, the drive motor 51 rotates reversely the pressing roller 43 at 90 mm/sec.

In the sleep mode, as the fixing belt 42 is not heated, the temperature of the fixing belt 42 is lower than the preheat temperature. The image forming apparatus 1 changes to the sleep mode, when a certain time (27 minutes, for example) elapses in the preheat mode. The nip pressure in the sleep mode is lower than the nip pressure in the warming up mode. The nip pressure in the sleep mode may be made equal to the nip pressure in the preheat mode. In sleep mode, the drive motor 51 does not rotate the pressing roller 43.

In the preheat return mode, the image forming apparatus 1 becomes in the ready mode from the preheat mode. In the preheat return mode, the fixing belt 42 becomes at the fixing temperature from the preheat temperature. The nip pressure in the preheat return mode is higher than the nip pressure in the ready mode. The nip pressure in the preheat return mode may be made equal to the nip pressure in the fixing mode. In the preheat return mode, the drive motor 51 rotates forwardly the pressing roller 43 at 270 mm/sec.

In the sleep return mode, the image forming apparatus 1 becomes in the ready mode from the sleep mode. In the sleep return mode, the fixing belt 42 becomes at the fixing temperature from a temperature lower than the preheat temperature. The nip pressure in the sleep return mode is higher than the nip pressure in the ready mode. The nip pressure in the sleep return mode may be made equal to the nip pressure in the fixing mode. In the sleep return mode, the drive motor 51 rotates forwardly the pressing roller 43 at 270 mm/sec.

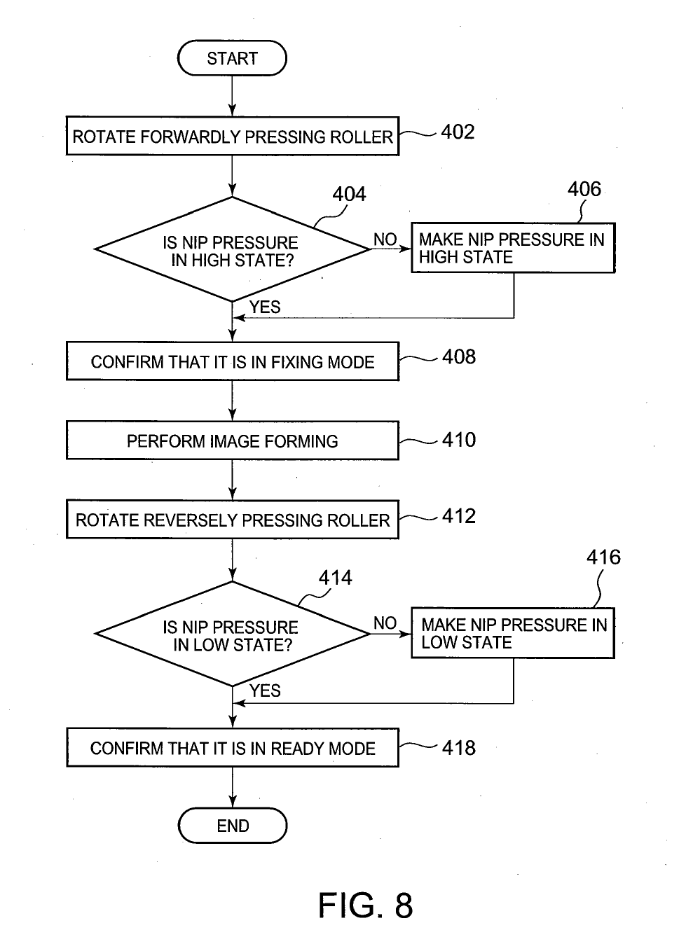

FIG. 8 is a flow chart showing an operation of the image forming apparatus 1 to transit from the fixing mode to the ready mode after image forming.

The image forming apparatus 1 rotates forwardly the pressing roller 43 (402).

The image forming apparatus 1 confirms current mode. The image forming apparatus 1 detects the fixing mode by the shutter 83 not shielding the sensor 84. The nip pressure is in the high state then (404).

If the shutter 83 shields the sensor 84, the cam 81 and the shutter 83 are rotated by flowing current in the electromagnetic clutch gear 101 till the shutter 83 does not shield the sensor 84 so as to make the nip pressure in the high state, while rotating the pressing roller 43 forwardly (406).

The image forming apparatus 1 rotates the pressing roller 43 forwardly and confirms that the nip pressure is in the high state in the fixing mode (408), and performs image forming. The image forming apparatus 1 takes out the sheet P from the sheet cassette 4 or the manual sheet feeder 31. The image forming apparatus 1 conveys the sheet P from the aligning roller 36 to the secondary transfer roller 27 along the conveying path 34. The image forming apparatus 1 conveys the sheet P on which the toner image is transferred to by the secondary transfer roller 27 to the fixing device 37. The image forming apparatus 1 in the fixing mode rotates forwardly the pressing roller 43 in the direction of the arrow t. The fixing roller 38 rotates driven by the pressing roller 43. The nip portion 50 formed by the fixing roller 38 and the pressing roller 43 fixes the toner image on the sheet P by applying heat and pressure. The image forming apparatus 1 finishes image forming by ejecting the sheet P on which the toner image is fixed to the sheet ejector 3 (410).

The image forming apparatus 1 rotates the pressing roller 43 reversely after finishing image forming (412).

The image forming apparatus 1 confirms that the shutter 83 shields the sensor 84 so as to confirm that the nip pressure is in the low state (414).

If the shutter 83 does not shield the sensor 84, the cam 81 and the shutter 83 are rotated by flowing current in the electromagnetic clutch gear 101 till the shutter 83 shields the sensor 84 so as to make the nip pressure in the low state, while rotating the pressing roller 43 reversely (416).

The image forming apparatus 1 becomes in the ready mode if the shutter 83 shields the sensor 84 while rotating the pressing roller 43 reversely (418).

When the pressing roller 43 rotates reversely, as the flexure of the fixing belt 42 is difficult to happen at the face facing the separator 52a, even if the nip pressure lowers and the foamed rubber layer 38b is restored, the fixing belt 42 becomes difficult to contact, as the orbit is stable even though approaching the separator 52a. When the pressing roller 43 rotates forwardly, as the face of the fixing belt 42 facing the first temperature sensor 53a and the second temperature sensor 53b goes tight, the first temperature sensor 53a and the second temperature sensor 53b can detect the temperature of the fixing belt 42 more accurately. In the mode to raise the temperature rapidly such as the warming up mode, the preheat return mode and the sleep return mode, the pressing roller 43 is rotated forwardly and the temperature is detected accurately to avoid overheating.

To make the rotation speed of the pressing roller 43 lower when the pressing roller 43 rotates reversely than when the pressing roller 43 rotates forwardly can suppress the damage of the fixing belt 42 even if the fixing belt 42 makes contact with the separator 52a.

In place of moving an absolute position of the pressing roller 43 so as to change the nip pressure, an absolute position of the fixing roller 38 may be moved, and both the absolute positions may be changed.

The rotation speed of the pressing roller 43 according to the temperature difference between the fixing belt 42 and the pressing roller 43 in the return mode is not limited. The rotation speed of the pressing roller 43 may be changed according to the property of the fixing device 37, such as a branch point of the changing temperature difference of the fixing belt 42, and the number of variations of the rotation speeds of the fixing belt 42.

### Second Embodiment

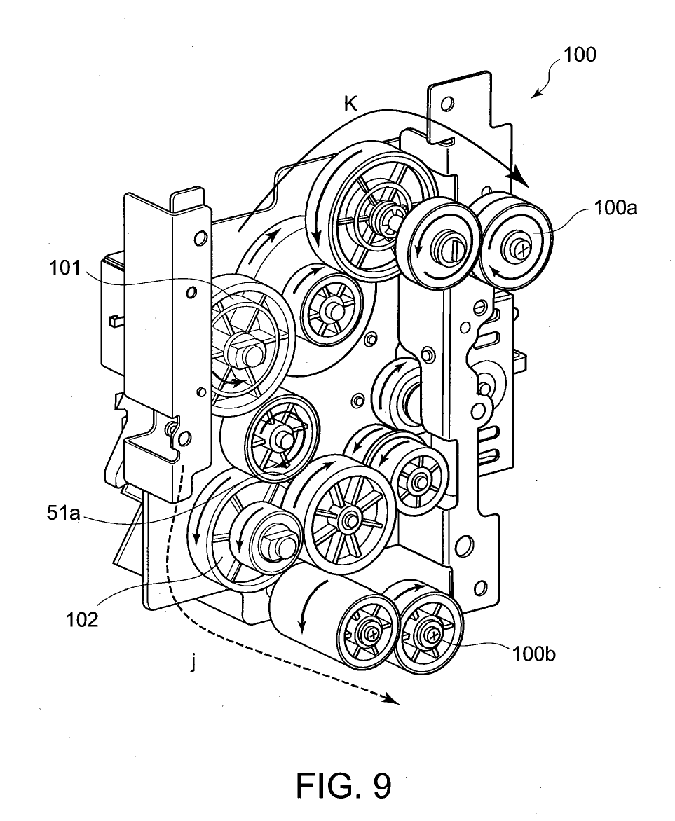

FIG. 9 is a view showing a gear sequence 100 to control a rotation direction of the pressing roller 43 and the nip pressure in a second embodiment. The gear sequence 100 includes a plurality of gears, the motor shaft 51a, the electromagnetic clutch gear 101 and a sub-electromagnetic clutch gear 102. The sub-electromagnetic clutch gear 102 is a clutch to switch over whether to transmit or to cut the rotation of the motor shaft 51a to the pressing roller 43. The sub-electromagnetic clutch gear 102 is a two-stage gear composed of an upper stage and a lower stage, and the operation changes by whether or not to flow the current. The upper stage gear connects so as to follow with the rotation of gears in the direction of the arrow j. When current is flown, the upper stage along with the lower stage of the two-stage gear rotate, and rotate gears in the direction of the arrow j, which are ranging to the gear 100b. When the current is cut off, the gear of the upper stage runs idle and the gear of the lower stage rotates.

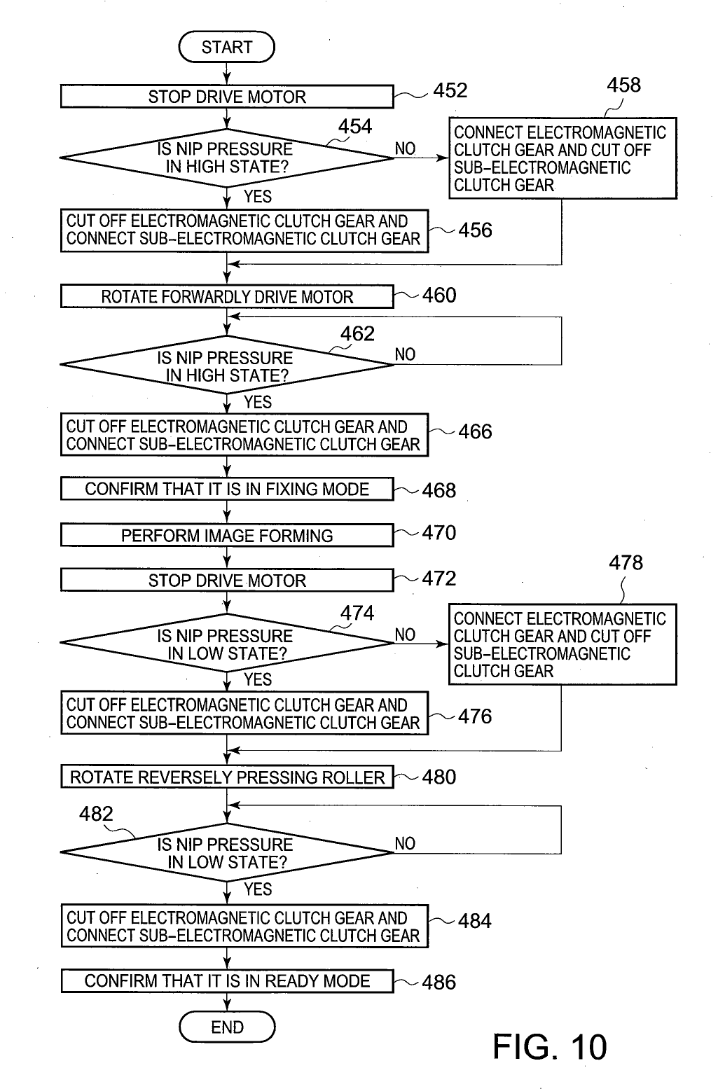

A flow of the forward rotation and the reverse rotation of the pressing roller 43 will be described. FIG. 10 is a flow chart showing an operation of the image forming apparatus 1 to transit from the fixing mode to the ready mode after image forming in the second embodiment.

The image forming apparatus 1 stops the drive motor 51 (452).

The image forming apparatus 1 confirms current mode. The image forming apparatus 1 detects the fixing mode by the shutter 83 not shielding the sensor 84. The nip pressure is in the high state then (454). If the shutter 83 does not shield the sensor 84, the image forming apparatus 1 cuts off the electromagnetic clutch gear 101 and connects the sub-electromagnetic clutch gear 102 (456). If the shutter 83 shields the sensor 84, the image forming apparatus 1 connects the electromagnetic clutch gear 101 and cuts off the sub-electromagnetic clutch gear 102 so as to make the nip pressure in the high state (458).

The image forming apparatus 1 rotates the drive motor 51 forwardly (460).

The image forming apparatus 1 confirms current mode. If the electromagnetic clutch gear 101 is connected and the sub-electromagnetic clutch gear 102 is cut off, the nip pressure becomes in the high state by the rotation of the cam 81 and the pressing roller 43 does not rotate. The image forming apparatus 1 confirms that the shutter 83 does not shield the sensor 84 so as to confirm that the nip pressure is in the high state (462). If the shutter 83 does not shield the sensor 84, the image forming apparatus 1 cuts off the electromagnetic clutch gear 101 and connects the sub-electromagnetic clutch gear 102 (466). If the electromagnetic clutch gear 101 is cut off and the sub-electromagnetic clutch gear 102 is connected, the cam 81 does not rotate, but the pressing roller 43 rotates.

The image forming apparatus 1 rotates the pressing roller 43 forwardly and confirms that the nip pressure is in the high state in the fixing mode (468), and performs image forming (470).

The image forming apparatus 1 stops the drive motor 51 when image forming is finished (472).

The image forming apparatus 1 confirms that the shutter 83 shields the sensor 84 so as to confirm that the nip pressure is in the low state (474). If the shutter 83 shields the sensor 84, the image forming apparatus 1 cuts off the electromagnetic clutch gear 101 and connects the sub-electromagnetic clutch gear 102 (476). If the shutter 83 does not shield the sensor 84, the image forming apparatus 1 connects the electromagnetic clutch gear 101 and cuts off the sub-electromagnetic clutch gear 102 so as to make the nip pressure in the low state (478).

The image forming apparatus 1 rotates the drive motor 51 reversely (480).

The image forming apparatus 1 confirms that the shutter 83 shields the sensor 84 so as to confirm that the nip pressure is in the low state (482). If the electromagnetic clutch gear 101 is connected and the sub-electromagnetic clutch gear 102 is cut off, the cam 81 rotates, the nip pressure becomes in the low state and the pressing roller 43 does not rotate. If the shutter 83 becomes to shield the sensor 84, the image forming apparatus 1 cuts off the electromagnetic clutch gear 101 and connects the sub-electromagnetic clutch gear 102 (484).

The image forming apparatus 1 rotates the pressing roller 43 reversely, and becomes to the ready mode (486).

In the second embodiment, the position of the fixing belt 42 moves against the separator 52 and is easy to contact the separator 52, and at the time of changing the nip pressure, the pressing roller 43 and the fixing belt 42 are not rotated.

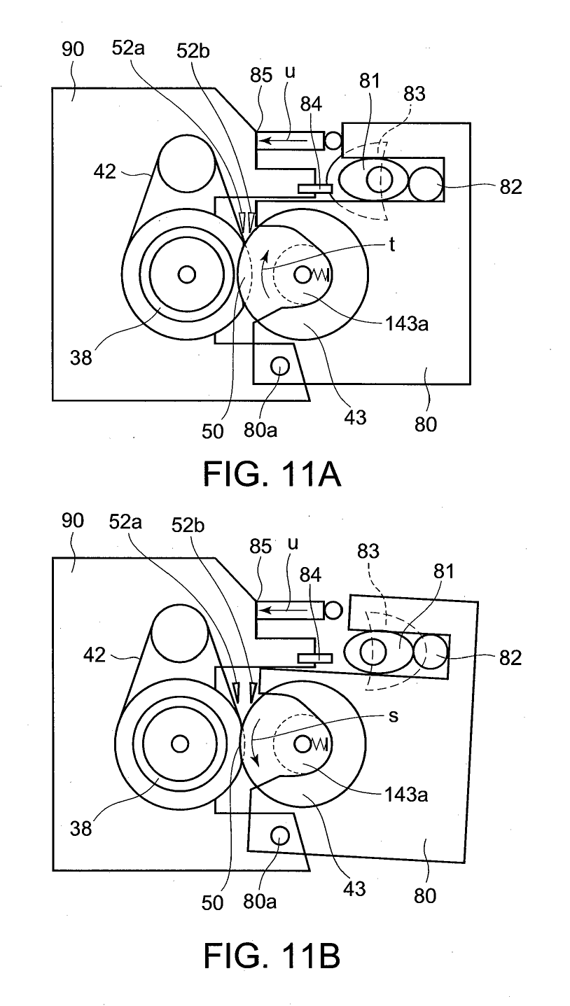

Whether the nip pressure is in the high state or in the low state may be different from the operation of FIG. 6. That is, the nip pressure may be in the high state, when the shutter 83 shields the sensor 84 as shown in FIG. 11A, and the nip pressure may be in the low state when the shutter 83 does not shield the sensor 84 as shown in FIG. 11B.

The fixing belt 42 and the pressing roller 43 may contact with each other in the state that the nip pressure is low, and may be separated so as not to connect with each other.

While certain embodiments have been described, those embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A fixing device comprising:
a fixing roller comprising an elastic layer;
a fixing belt wound around the fixing roller;
a satellite roller to set up the fixing belt between the fixing roller and the satellite roller;
a pressing roller to nip hold the fixing belt between the fixing roller and the pressing roller;
a separator to separate a sheet at a position separate from the fixing belt;
a pressure changing mechanism to change a nip pressure between the fixing roller and the pressing roller; and
a driving device to rotate the fixing belt in a first direction when the nip pressure is a first nip pressure and to rotate the fixing belt in a second direction which is reverse to the first direction when the nip pressure is a second nip pressure which is lower than the first nip pressure.

2. The device of claim 1, wherein a toner image is fixed on the sheet, while conveying the sheet from an upstream to a downstream by the fixing belt rotating in the first direction.

3. The device of claim 2, wherein the separator separates the sheet from the fixing belt at the downstream side than a nip formed by the fixing roller and the pressing roller.

4. The device of claim 3, wherein the satellite roller sets up the fixing belt at the downstream side against the fixing roller.

5. The device of claim 4, further comprising:
a coil to induction heat the fixing belt.

6. The device of claim 5, wherein the driving device rotates the fixing belt at a first speed in the first direction and rotates the fixing belt at a second speed which is slower than the first speed in the second direction.

7. The device of claim 6, wherein the coil holds a temperature of the fixing belt rotating in the first direction at a first temperature, and raises a temperature of the fixing belt rotating in the second direction from a second temperature which is lower than the first temperature to the first temperature.

8. The device of claim 7, wherein the pressure changing mechanism includes:
a spring to attract the fixing roller and the pressing roller;
a cam to separate the fixing roller from the pressing roller; and
a sensor to detect a position of the cam.

9. An image forming apparatus comprising:
an image forming portion to form a toner image on a sheet;
a fixing roller comprising an elastic layer;
a fixing belt wound around the fixing roller to heat the toner image;
a satellite roller to set up the fixing belt between the fixing roller and the satellite roller;
a pressing roller to nip hold the fixing belt between the fixing roller and the pressing roller, and to press the sheet to the fixing belt;
a separator to separate the sheet at a position separate from the fixing belt;
a pressure changing mechanism to change a nip pressure between the fixing roller and the pressing roller; and
a driving device to rotate the fixing belt in a first direction when the nip pressure is a first nip pressure and to rotate the fixing belt in a second direction which is reverse to the first direction when the nip pressure is a second nip pressure which is lower than the first nip pressure.

10. The apparatus of claim 9, wherein the toner image is fixed on the sheet, while conveying the sheet from an upstream to a downstream by the fixing belt rotating in the first direction.

11. The apparatus of claim 10, wherein the separator separates the sheet from the fixing belt at the downstream side than a nip formed by the fixing roller and the pressing roller.

12. The apparatus of claim 11, wherein the satellite roller sets up the fixing belt at the downstream side against the fixing roller.

13. The apparatus of claim 12, further comprising:
a coil to induction heat the fixing belt.

14. The apparatus of claim 13, wherein the driving device rotates the fixing belt at a first speed in the first direction and rotates the fixing belt at a second speed which is slower than the first speed in the second direction.

15. The apparatus of claim 14, wherein the coil holds a temperature of the fixing belt rotating in the first direction at a first temperature, and raises a temperature of the fixing belt rotating in the second direction from a second temperature which is lower than the first temperature to the first temperature.

16. The apparatus of claim 15, wherein the pressure changing mechanism includes:
a spring to attract the fixing roller and the pressing roller;
a cam to separate the fixing roller from the pressing roller; and
a sensor to detect a position of the cam.

17. A method for fixing an image, comprising:
forming a toner image on a sheet;
pressing the sheet to a fixing belt by a pressing roller with a first nip pressure while heating the toner image by the fixing belt wound around a satellite roller and a fixing roller comprising an elastic layer rotating in a first direction;
separating the sheet by a separator at a position separate from the fixing belt; and
rotating the fixing belt in a second direction which is reverse to the first direction while making the nip pressure a second nip pressure which is lower than the first nip pressure by a pressure changing mechanism.

18. The method of claim 17, wherein the toner image is fixed on the sheet, while conveying the sheet from an upstream to a downstream by the fixing belt rotating in the first direction.

19. The method of claim 18, wherein the separator separates the sheet from the fixing belt at the downstream side than a nip formed by the fixing roller and the pressing roller.

20. The method of claim 19, wherein the satellite roller sets up the fixing belt at the downstream side against the fixing roller.
